(19) United States
(12) Patent Application Publication
(10) Pub. No.: US 2009/0149977 A1
(43) Pub. Date: Jun. 11, 2009

(54) METHODS, SYSTEMS, AND COMPUTER PROGRAM PRODUCTS FOR SHAPING MEDICAL IMPLANTS DIRECTLY FROM VIRTUAL REALITY MODELS

(76) Inventor: Stephen A. Schendel, Menlo Park, CA (US)

Correspondence Address: Nixon Peabody LLP, 200 Page Mill Road, Palo Alto, CA, 94306, US

(21) Appl. No.: 12/263,309

(22) Filed: Oct. 31, 2008

Related U.S. Application Data
(60) Provisional application No. 60/985,646, filed on Nov. 6, 2007.

(51) Int. Cl. G06F 19/00

(52) U.S. Cl. 700/98

(57) ABSTRACT

A virtual interactive environment enables a surgeon or other medical professional to manipulate implants, prostheses, or other instruments using patient-specific data from virtual reality models. The patient data includes a combination of volumetric data, surface data, and fused images from various sources (e.g., CT, MRI, x-ray, ultrasound, laser interferometry, PET, etc.). The patient data is visualized to permit a surgeon to manipulate a virtual image of the patient's anatomy, the implant, or both, until the implant is ideally positioned within the virtual model as the surgeon would position a physical implant in actual surgery. Thus, the interactive tools can simulate changes in an anatomical structure (e.g., bones or soft tissue), and their effects on the external, visual appearance of the patient. CAM software is executed to fabricate the implant, such that it is customized for the patient without having to modify the structures during surgery or to produce a better fit.

### CROSS-REFERENCE TO RELATED APPLICATIONS

This application claims the benefit of U.S. Provisional Patent No. 60/985,646, filed Nov. 6, 2007, incorporated herein by reference in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to medical imaging systems and techniques. More particularly, the present invention relates to techniques for displaying and manipulating high-resolution, three-dimensional medical images for the fabrication of medical implants.

### BACKGROUND OF THE INVENTION

It is well known that implants and prostheses have been applied by medical professionals to replace damaged or missing anatomical structures within a patient and to thereby improve the patient's quality of life. To aid medical professionals in this endeavor, computer-assisted technology has been developed to enable an implant to be designed and viewed in a virtual world prior to building a physical implant. For example, graphics software can be used to create an image or a virtual model of a patient's anatomy, such as an injured face in need of reconstructive surgery. The virtual model can be based on medical data obtained from a data file including physiological information about a hypothetical patient having the same age and sex of the actual patient. The graphics software can include routines that permit a surgeon to interact with the virtual model to simulate surgery on the facial bones. Using the graphics software, the virtual model of the patient's skull can be cut and manipulated into a desired configuration as one would in the actual surgery.

Based on the virtual model of the patient's skull, an implant, such as fixation plate, can be constructed or modified by rapid prototyping, stereolithography, or similar technology preceding or during surgery. The implant is physically constructed from the virtual model, but since the virtual model is not based precisely on the physiological data of the actual patient, the implant will likely require further adjustments prior to being placed in the actual patient. The implant, therefore, would need to be cut using a saw or drill, and then the patient's bones may need to be physically repositioned or bent into the desired shape and position to correct the original deformity. Since the implant must be altered to fit the specific patient and the altered anatomy, this process typically occurs in the operating room, and consequently prolongs the surgical procedure and limits the ability to precisely position the bones.

Therefore, conventional techniques for fabricating and adjusting implants can be expensive and time-consuming. In additional, unplanned events and complications arising during surgery can contribute to the patient's physiology and deformed area being dramatically different from the patient's virtual model. Therefore, the actual position of repositioned bones can be different than that planned pre-operatively, which results in the implant requiring further adjustments or redesign and a possibly impaired end result.

It is desirable to provide methods and software-related tools that overcome the above-described problems and provide an efficient and cost-effective manner for fabricating implants preceding and during surgical or other medical procedures.

### BRIEF SUMMARY OF THE INVENTION

As described herein, the present invention relates to methods, systems, and computer program products that enable a physician, clinician, or other medical professional to design and manipulate the configuration mid structure of medical implants, prostheses, or other bio-medical instruments using patient-specific data sets from computer-simulated, three-dimensional, virtual reality models.

The patient-specific data can be obtained from a plurality of sources, including, but not limited to, computed tomography (CT), magnetic resonance imaging (MRI), cone beam CT, NewTom, i-CAT, x-ray, ultrasound, laser interferometry, positron emission tomography (PET), or the like. The patient-specific data can include volumetric data merged with surfacing scanning systems, which include data representing the external visual appearance or surface configuration of the patient, The patient-specific data can also include fused images from a plurality of sources.

After capturing or retrieving the patient-specific data, the raw data is visualized on an interactive user interface to render a high-resolution, three-dimensional virtual model of the patient's anatomical structures. The virtual model is used for computer-aided engineering (CAL) analyses, such as, e.g., simulating surgery on the facial bones of an injured patient.

During the visualization and analysis phase, a host of virtual cutting and shaping tools can be employed to segment the elements of the virtual model to thereby separate bones from soft tissue and air, as well as cut and reposition the bones into a new or desired position. A surgeon or other medical professional can also interact with the virtual model to design, modify, or manipulate a virtual image of an implant to be positioned within the patient. For example, a standard fixation plate can be selected from a list of virtual plates in a computer memory. The virtual plate is then placed in the desired position on the altered virtual model, then adapted and modified to fit the amount of bone displacement and surface contours as shown on a display for the user interface.

Therefore, the virtual model permits cutting and manipulation of a three-dimensional image of the patient's anatomy, the implant, or a combination of both, until the implant is ideally positioned within the virtual model as a surgeon would position a physical implant in an actual surgery. For example, a surgeon can use the virtual cutting and shaping tools to reshape or re-construct a portion of a patient's anatomy (such as, a face injured in accident) in addition to pre-operatively planning for the placement of an implant. Thus, software routines and functions are included to simulate changes in the virtual environment of the anatomical position or shape of an anatomical structure (e.g., bones or soft tissue structure), the size, shape and placement of the virtual implant and, thus, to allow assessment of their effects on the external, visual appearance of the patient. The elements of the anatomical structure can be analyzed by the surgeon in either static (e.g., no movement of the anatomical structures relative to each other) or dynamic (e.g., movement of anatomical structures relative to each other, such as chewing, occlusion, etc.) formats. In an embodiment, haptic feedback is integrated with the user interface to enable the surgeon to feel the virtual bones and virtual implant as an input device moves a pointer around the display.

After the surgeon or other medical professional has finalized the virtual configuration and specifications for the implant, a computer aided manufacturing (CAM) system accesses the data specifying the virtual model of the implant to fabricate a physical model of the implant. For example, a CAM software program is executed to control machinery using additive manufacturing techniques, such as rapid prototyping, stereolithography, or other like technology, to produce an implant that is personalized for the specific patient. Thereafter, the implant can be positioned in the patient during the surgical or other medical procedure with little or no subsequent manipulation

Thus, the methods, systems, and computer program products of the present invention provide for the design and fabrication of a medical implant, prosthesis, and other instrument that is customized for the end-user/patient while reducing the probability of needing to modify the structures during surgery or other medical procedures to produce a better aesthetic and functional result. In addition, the conventional intermediate step of creating a physical model can be bypassed.

The above described and many other features of the present invention will become apparent, as the invention becomes better understood by reference to the following detailed description when considered in conjunction with the accompanying drawings.

### BRIEF DESCRIPTION OF THE DRAWINGS

The invention is illustrated in the figures of the accompanying drawings, which are meant to be exemplary and not limiting, in which like reference numbers indicate identical or functionally similar elements, additionally in which the leftmost digit(s) of a reference number identifies the drawing in which the reference number first appears, and in which:

FIG. 1 illustrates a general operational flow for shaping a medical implant from a virtual reality model according to an embodiment of the present invention; and

FIG. 2 illustrates a virtual interactive system according to an embodiment of the present invention.

### DETAILED DESCRIPTION OF PREFERRED EMBODIMENTS

In the following description of embodiments of the invention, reference is made to the accompanying drawings that form a part hereof and in which is shown by way of illustration a number of specific embodiments in which the invention can be practiced. It is to be understood that other embodiments can be utilized and structural changes can be made without departing from the scope of the present invention.

Methods, systems, computer program products are described herein for a virtual interactive tool for designing and manipulating the configuration and structure of medical implants, prostheses, or other bio-medical instruments by computer aided manufacturing (CAM) using patient-specific data sets from computer-simulated three-dimensional, virtual reality models. The virtual models can be web-based or can be generated via any other computer-implemented technologies.

The virtual interactive tool of the present invention enables a physician, clinician, or other medical professional to accomplish the task of preoperative surgical planning with integrated, clinically accurate simulation of a surgical result; provide for interaction with an easy-to-use, intuitive interface; is easily accessible and available worldwide with no requirement of special hardware; and is available on an as-needed, per patient, potentially billable service. The end result is a medical implant and other devices are customized for the end-user/patient while reducing the probability of having to modify the structures during surgery to produce a better fit. In addition, the conventional intermediate step of creating a physical model can be bypassed.

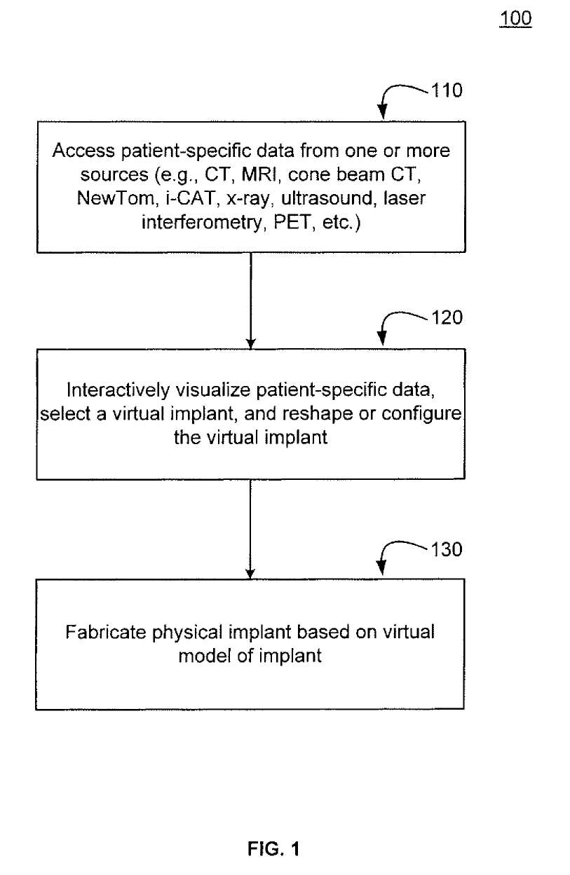

FIG. 1 illustrates a general operational flow 100 for shaping a medical implant from a virtual reality model according to an embodiment of the present invention. At step 110, patient-specific data set is accessed from a medically accurate or reliable source, such as computed tomography (CT) scans, magnetic resonance imaging (MRI), cone beam CT imaging, NewTom scans, i-CAT imaging, x-ray images, ultrasound data, laser interferometry measurements, positron emission tomography (PEI) scanning, or the like. The patient-specific data can include volumetric data merged with surfacing scanning systems, either photographic or laser-based, which include data representing the external visual appearance or surface configuration of the patient. The patient-specific data can also include fused images from a plurality of sources.

After accessing in the patient-specific data, the raw data is visualized on an interactive user interface to render a high-resolution, three-dimensional virtual model of at least a portion of the patient's anatomy at step 120. The virtual model is used for computer-aided engineering (CAE) analyses, such as, e.g., simulating surgery on the facial bones of an injured patient.

Once the raw data are viewed, a medical professional, technician, or other operator can review, edit, calibrate, or revise the raw data as desired. Thereafter, the raw data can be automatically or semi-automatically segmented to generate the three-dimensional virtual. The entire volume of the patient-specific data or on a user-selected sub-region of the data can used to produce the virtual model. A sub-region can be selected, for example, to constrain memory allocation and processing requirements.

The present invention supports various segmentation operations, including, but not limited to, traditional (e.g., Hounsfeld thresholding, windowing, histogram analysis); convolutions (e.g., three-dimensional and two-dimensional-based edge and surface detection kernels); three-dimensional morphological operations (e.g., opening, closing, connected components) that are effective for, e.g., low signal-noise data; and other advanced voxel classification techniques.

Once one or more segmentation operators are used to classify each voxel, a mesh generation process can commence. In this case, both traditional Marching Cubes and an enhanced algorithm with on-the-fly mesh reduction are implemented. Once the initial surface mesh is generated, a number of automated mesh analysis techniques are employed, including, but not limited to the elimination of disconnected triangles; mesh-based connected components analysis and elimination of spurious objects; triangle retessellation to eliminate triangles of high eccentricity; analysis and correction of surface normal and vertex order; flash artifact removal based on point-based noise in surface curvature; and mesh reduction and triangle merging in areas of low curvature.

Since the mesh has been generated in the same world coordinate space as the original voxel data, an integrated, registered geometric and volumetric display can be provided to the system operator in order to verify and understand the patient's condition. A series of interactive tools for three-dimensional celphalometric analysis are provided for measuring distances, angles, and identifying landmarks in order to quantify the patient condition.

While the previous actions provided the basis for visualization and examination of the patient's current condition, advancing toward prediction of surgical outcome requires the use of simulation. Since a geometric model of the patient's bone and soft tissue structure can be visualized as described above, the generated mesh is now used with a mass-spring engine or finite element model in order to model the soft tissue dynamics.

In an embodiment, the virtual model based on the patient-specific data can be segmented to separate bone, soft tissue and air either automatically or by interactive manipulation. Virtual cutting and shaping tools are included to cut and reposition the bones into a new or desired position. Examples of a virtual interactive systems that include virtual cutting and shaping tools are described in U.S. Pat. No. 6,608,628 to Ross et al. and in the article by S. Schendel et al., “A Surgical Simulator for Planning and Performing Repair of Cleft Lips,” Journal of Cranio-Maxillo-Facial Surgery, 33(4), 223-8, August 2005, both of which arc incorporated herein by reference in their entireties.

A surgeon or other medical professional or technician can also interact with the virtual model of the patient to design, modify, or manipulate a virtual image of an implant to be positioned within the patient. In other words, the virtual implant can be modified. For example, a standard fixation plate can be selected from a list of virtual plates in the computer memory. The virtual plate is then placed in the desired position on the altered virtual model and adapted (for example, in terms of its size, shape and placement) to fit the amount of bone displacement and surface contours as shown on the display.

Therefore, the virtual model permits cutting and manipulation of a three-dimensional image of the patient's anatomy, the implant, or a combination of both, until the implant is ideally positioned within the virtual model as a surgeon would position a physical implant in an actual surgery. Therefore, during this process, a surgeon can use the virtual interactive environment of the present invention to reshape or re-construct a portion of a patient's body (such as, a face injured in accident) in addition to pre-operatively planning for the placement of an implant. In an embodiment, a haptic device is integrate with an input device for virtual interactive environment to provide force-feedback to the surgeon, such that the surgeon can feel the virtual bone and/or the virtual implant as the input device moves a pointer around the display.

During the interactive visualization of the virtual model, standard axial, sagittal, and coronal viewing plans, as well as arbitrary cutting planes can be supported. In addition, full volume rendering of the entire patient dataset can also be supported for full, interactive visualization of the patient data. During visualization, traditional windowing (e.g., levels and contrast enhancements, medical imaging and pattern recognition (MIPR), and the like) are available, as are other visualization tools for this data.

At step 130, a computer aided manufacturing (CAM) system accesses the data specifying the virtual model of the implant, as configured and finalized by the operator, to fabricate a physical model of the implant using additive manufacturing techniques, such as rapid prototyping, stereolithography, or other like technology. Such techniques are described in greater detail by M. Robiony el al., “Cranio-Maxillofacial Bone Surgery,” J Oral Maxfac Surg (2007) 1198-1208; Ono I et al., “Method for Preparing an Exact-Size Model Using Helical Volume Scan Computed” Plast Reconstr Surg (1994) 93: 1363; S. Swan, “Integration of MRI and Stereolithography to Build Medical Models. A Case Study,” Rapid Prototyping Journal, (1996) 2:41; H. P. Wolfet al., “High Precision 3-D Model Design Using CT and Stereolithography,” CAS (1994) 1:46.

The machinery that creates or modifies the implant, or components for the implants, is controlled by a CAM software program that requires specific information to define the geometry of the affected operation, the tool orientation, and part being modified. The CAM system includes robot bending apparatus. Examples of such CAM systems are described in U.S. Pat. No. 7,245,977 to Simkins and U.S. Pat. No. 7,076,980 to Butscher et al., both of which are incorporated herein by reference in their entireties. Implants, such as fixation plates, are most frequently made of titanium or resorbable materials.

During the surgical or other medical procedure, the bones, for example, can be cut using a saw or drill, and thereafter physically repositioned into a desired position to correct the original deformity. These bones can be held in the new position by plates and screws. Since the implant is fabricated based on the virtual model of the patient's anatomy and a desired position as previously determined by the surgeon, the implant is, therefore, personalized for the specific patient, and the implant can be placed during the surgical procedure with little or no subsequent manipulation.

As such, the methods, systems, and computer program products of the present invention provides distinct advantages over conventional techniques for forming and positioning implants. Because the implant is fabricated based on a virtual model of patient-specific data that has been altered to form the new desired virtual image for the desired outcome, the conventional, intermediate step of creating a physical model on which an implant must then be manually bent or re-structured by a surgeon either prior to or during a surgical procedure can be avoided. The elimination of this intermediate step saves time during the operation and increases the precision of the surgical procedure. Precision is increased, as the final position of the bones is determined by the shape of the implants that have been pre-shaped from the virtual surgery. Thus if the implants fit, the bones are in the correct position as determined by the virtual surgery and the desired result is thus achieved.

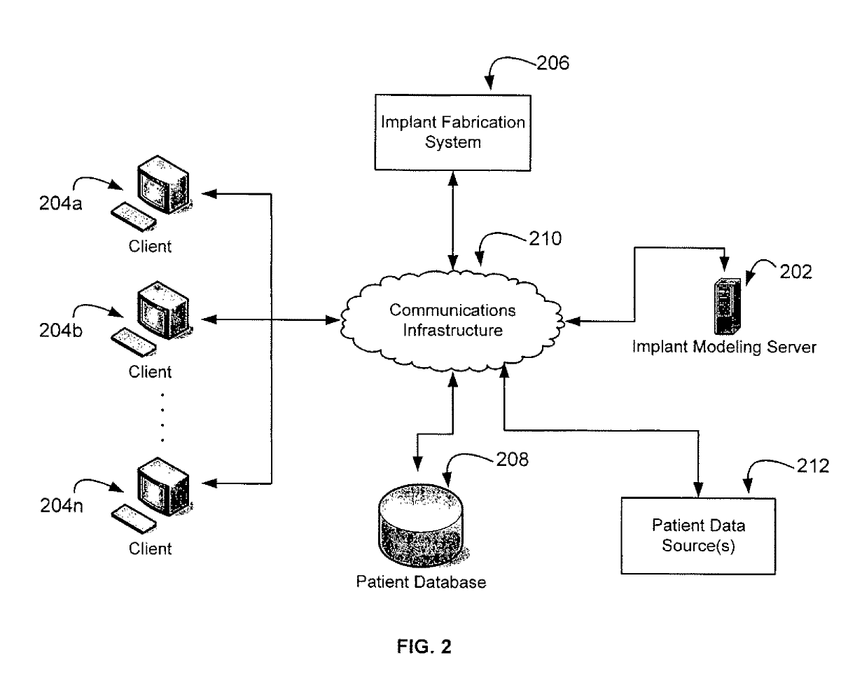

FIG. 2 illustrates a virtual interactive system 200 according to an embodiment of the present invention. System 200 includes at least one implant modeling server 202 that is communicatively coupled to one or more clients 204a-204n by communications infrastructure 210. It should be understood that the system 200, as described herein, is an exemplary system for implementing various aspects of the present invention. Various modifications can be made without departing from the scope of the present invention. For example, the quantity of system components illustrated in FIG. 2 can be increased or decreased as desired by the system architect.

Clients 204a-204n can be represented by a variety of devices, such as, personal computers, personal digital assistants, smart phones, or the like. Clients 204a-204n can include one or more output mechanisms that output information to the user (e.g., physician, surgeon, clinician, technician, other medical professionals, or the like). Such output mechanisms include a monitor, an LCD screen, a printer, a speaker, or the like. One or more input mechanisms can be included to permit a user to input information to the clients 204a-204n. Such input mechanisms include a keyboard, a mouse, a stylus, voice recognition mechanisms, biometric mechanisms, or the like.

Clients 204a-204n can include client software such as web browser software. The web browser software can include a browser program, such as the MICROSOFT® INTERNET EXPLORER® browser application. For example, clients 204a-204n can access the software tools, patient data, or other information residing on implant modeling server 202 or other system components via the web browser software when the communications infrastructure 210 includes the global-based Internet. The web browser software can include a plug-in, applet or similar executable process. A plug-in can be obtained from the implant modeling server 202 or from a third party, disk, tape, network, CD-ROM, or the like. Alternatively, plug-ins can be pre-installed on clients 204a-204n.

Clients 204a-204n comprise network interface hardware and software that allow the clients 204a-204n to transmit and receive data over communications infrastructure 210. Communications infrastructure 210 can be a wired and/or wireless local area network (LAN), virtual LAN (VLAN), wide area network (WAN), and/or metropolitan area network (MAN), such as an organization's intranet, a local internet, the global-based Internet (including the World Wide Web (WWW)), an extranet, a virtual private network (VPN), licensed wireless telecommunications spectrum for digital cell (including CDMA, TDMA, GSM, EDGE, GPRS, CDMA2000, WCDMA FDD and/or TDD or TD-SCDMA technologies), or the like. Communications infrastructure 210 can support wired, wireless, or combinations of both transmission media, including satellite, terrestrial (e.g., fiber optic, copper, UTP, STP, coaxial, hybrid fiber-coaxial (HFC), or the like), radio, free-space optics, microwave, and/or any other form or method of transmission.

Patient-specific data used to generate a virtual model, as described above with reference to FIG. 1, can be obtained from one or more patient data sources 212. The data sources 212 include imaging devices; scanners; static or video cameras; x-ray, MRI or ultrasound equipment; or the like. The data sources 212 can be located at the physical location of the client 204a-204n being operated by the medical professional, or one or more of the data sources 212 can located at a remote site (e.g., at a laboratory, clinic, or hospital) from the location of the medical professional.

As discussed, clients 204a-204n include a local memory, and the patient-specific data obtained from the data sources 212 can be stored locally at the clients 204a-204n. Alternatively or in addition, digital information representing patient-specific data can be stored in a centralized patient database 208. The patient database 208 can be commercially available software, such as the database applications available from Oracle Corporation.

Implant modeling server 202 includes a set of computer executable instructions that cause a computer to visualize and manipulate a virtual reality model for diagnostics, therapeutics, and treatment planning, as described above with reference to FIG. 1. The instructions may be executed at the implant modeling server 202 and interactive images of the virtual model can be transmitted to the clients 204a-204n, or alternatively, an application program can be distributed to a client 204a-204n, so that the interactive visualization operations can be executed on the local client 204a-204n. The software instructions, therefore, include a set of functions or routines that cause the user interface for a client 204a-204n to display a high-resolution, three-dimensional representation of a patient's anatomical structures, and provide the medical professional with tools for visualizing and analyzing the virtual model. As discussed above, virtual cutting and shaping tools allow the medical professional to segment the model by showing slices or sections through the model at arbitrary, user-defined planes.

For example, the visualization tools include routines and functions for simulating changes in the anatomical position or shape of an anatomical structure (e.g., bones or soft tissue structure), and their effects on the external, visual appearance of the patient. The elements of the anatomical structure can be analyzed quickly in either static format (e.g., no movement of the anatomical structures relative to each other) or in a dynamic format (e.g., during movement of anatomical structures relative to each other, such as chewing, occlusion, etc.).

In an online environment, a web-based system 200 can be provided to import the patient-specific data in the standard Digital Imaging and Communications in Medicine (DICOM) format. The surgeon or other medical professional need only login to a web site (represented by implant modeling server 202), insert a CD-ROM containing the patient's data, and then use the interactive visualization tools of implant modeling server 202 to plan the procedure and simulate the result. By reading the patient-specific imaging data locally, the surgeon is in control of the patient data at all times, protecting privacy and ensuring security of data. Further, by reading this data locally, no patient data is transferred over the Internet connection (e.g., infrastructure 210), thus the system 200 does not require and significant Internet bandwidth beyond that typically available.

In an embodiment, an Active X control program is used to support data acquisition from CT and other sources (e.g., data source 212), segmentation, visualization, integrated surface and volume rendering, simulation, and estimation of surgical result. The user can load the patient data locally, can perform preoperative visualization, automated segmentation and computer-model generation, then interact with this model to perform osteotomies and distractions, and the system 200 can recalculate soft tissue deformation on top of the new bone structure.

Upon configuring and finalizing the virtual model of the implant, an implant fabrication system 206 accesses the specification data for the virtual model from client 204a-204n or implant modeling server 202, depending on which component contains the application for visualizing and finalizing the implant design. Implant fabrication system 206 includes a CAM software program that is executed to control machinery using additive manufacturing techniques, such as rapid prototyping, stereolithography, or other like technology, to produce an implant that is personalized for the specific patient. Thereafter, the implant can be positioned in the patient during the surgical procedure with little or no subsequent manipulation, as discussed above.

As described, the methods, systems, and computer program products of the present invention can be used for medical implants such as bone fixation plates, distraction devices, and various other implants and prostheses to replace a missing part or augment the skeleton. The present invention enables a medical professional to preoperatively plan a surgical or other medical procedure, and evaluate the outcomes, which, in turn, provides for a better surgical result, with potentially less time and expense in the operating room, and less chance of surgical revision. In addition, the techniques and methodologies of the present invention can be utilized in real time or near term during a surgical procedure to fabricate an implant.

The present invention can also be implemented to enable a user to practice procedures across a library of previously stored patient data to allow for better training across anatomical variations, pathologies, and conditions, and quantify surgical performance and result are very significant. Further, being able to generate a patient-specific surgical template or tissue engineered implant when appropriate can aid in translating the desired result to the patient. Finally, performing all this preoperative analysis before committing the patient to a course of surgical intervention is perhaps the greatest benefit.

The figures herein are conceptual illustrations allowing an explanation of the present invention. It should be understood that various aspects of the embodiments of the present invention could be implemented in hardware, firmware, software, or a combination thereof. In such an embodiment, the various components and/or steps would be implemented in hardware, firmware, and/or software to perform the functions of the present invention. That is, the same piece of hardware, firmware, or module of software could perform one or more of the illustrated blocks (e.g., components or steps). Unless explicitly stated otherwise herein, the ordering or arrangement of the steps and/or components should not be limited to the descriptions and/or illustrations hereof.

In software implementations, computer software (e.g., programs or other instructions) and/or data is stored on one or more machine readable media as part of a computer program product, and is loaded into or written on a computer system or other device or machine via a removable storage drive, hard drive, or communications interface. The software described herein need not reside on the same or a singular medium in order to perform the inventions described herein. Computer software can be implemented by any programming or scripting languages, such as C, C++, Java, Javascript, Action Script, or the like. Computer programs (also called computer control logic or computer readable program code) are stored in a various memory types, including main and/or secondary memory, and executed by one or more processors (controllers, or the like) to cause the one or more processors to perform the functions of the invention as described herein. In this document, the terms machine readable medium, computer program medium and computer usable medium are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, or the like); or the like.

Notably, the figures and examples above are not meant to limit the scope of the present invention to a single embodiment, but other embodiments are possible by way of interchange of some or all of the described or illustrated elements, Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s). Moreover, it is not intended for any term in the specification or claims to be ascribed an uncommon or special meaning unless explicitly set forth as such. Further, the present invention encompasses present and future known equivalents to the known components referred to herein by way of illustration. While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A computer-implemented method for shaping a medical implant from a virtual reality model, the method comprising:
accessing input data including digital information specific to a patient;
producing a virtual reality model from the input data, the virtual reality model including a digital representation of an anatomical structure of the patient;
receiving operator input to reshape at least one of the virtual reality model or a virtual medical implant positioned within the virtual reality model; and
applying an additive manufacturing technique to fabricate the medical implant from data representing the virtual medical implant.

2. The method of claim 1, wherein accessing input data comprises:
accessing digital information from at least one of a CT scan, MRI scan, cone beam CT image, NewTom scan, i-CAT image, x-ray image, ultrasound data, laser interferometry measurement, or PET scan.

3. The method of claim 1, wherein accessing input data comprises:
merging volumetric data with data representing an external visual appearance or a surface configuration of the patient.

4. The method of claim 1, wherein accessing input data comprises:
accessing a fused image of an anatomical structure of the patient.

5. The method of claim L, wherein receiving operator input comprises:
receiving input over a haptic user interface to reshape at least one of the virtual reality model or the virtual implant.

6. The method of claim 1, further comprising:
positioning the medical implant in the patient without modifying the medical implant to produce a desired fit.

7. A computer-implemented method for shaping a medical implant from a virtual reality model, the method comprising:
accessing input data including digital information specific to a patient;
receiving from a remote source an implant modeling application for causing a computer to render a virtual reality model from the input data, the virtual reality model including a digital representation of an anatomical structure of the patient;
receiving operator input to reshape at least one of the virtual reality model or a virtual implant positioned within the virtual reality model; and
sending instructions to a CAM application to cause a machine to execute an additive manufacturing technique to fabricate the medical implant from data representing the virtual implant.

8. The method of claim 7, wherein a first computer is provided to execute the accessing input data, receiving an implant modeling application, and receiving operator input steps, and wherein a second computer is provided to execute the sending instructions step.

9. The method of claim 7, wherein accessing input data comprises:
merging volumetric data with at least one of data representing an external visual appearance or a surface configuration of the patient or data representing a fused image of an anatomical structure of the patient.

10. A computer program product comprising a computer useable medium having computer readable program code functions embedded in the medium for causing one or more computers to shape a medical implant from a virtual reality model, the computer program product comprising:
a first computer readable program code function that causes a computer to access input data including digital information specific to a patient;
a second computer readable program code function that causes a computer to produce a virtual reality model from the input data, wherein the virtual reality model includes a digital representation of an anatomical structure of the patient;
a third computer readable program code function that causes a computer to receive operator input to reshape at least one of the virtual reality model or a virtual implant positioned within the virtual reality model; and
a fourth computer readable program code function that causes a computer to apply an additive manufacturing technique to fabricate the medical implant from data representing the virtual implant.

11. The computer program product of claim 10, wherein the first computer program readable program code function, the second computer program readable program code function, the third computer program readable program code function, and the fourth computer program readable program code function are executed on the same computer.

12. The computer program product of claim 10, wherein the first computer program readable program code function, the second computer program readable program code function, and the third computer program readable program code function are executed on a first computer, and the fourth computer program readable program code function are executed on a second computer.

13. The computer program product of claim 10, wherein the first computer program readable program code function is executed on a first computer, and the second computer program readable program code function, the third computer program readable program code function, and the fourth computer program readable program code function are executed on a second computer.

14. The computer program product of claim 10, wherein the first computer program readable program code function is executed on a first computer, the second computer program readable program code function and the third computer program readable program code function are executed on a second computer, and the fourth computer program readable program code function are executed on a third computer.

15. The computer program product of claim 10, wherein a third computer readable program code function comprises:
computer readable program code function that causes a computer to receive operator input over a haptic user interface to reshape at least one of the virtual reality model or the virtual implant.
